(19) United States
(12) Patent Application Publication
(10) Pub. No.: US 2022/0377543 A1
(43) Pub. Date: Nov. 24, 2022

(54) CONTROL DEVICE, NON-TRANSITORY COMPUTER READABLE STORAGE MEDIUM, AND SYSTEM

(71) Applicant: KABUSHIKI KAISHA TOKAI RIKA DENKI SEISAKUSHO, Aichi (JP)

(72) Inventor: Yosuke OHASHI, Aichi (JP)

(73) Assignee: KABUSHIKI KAISHA TOKAI RIKA DENKI SEISAKUSHO, Aichi (JP)

(21) Appl. No.: 17/704,261

(22) Filed: Mar. 25, 2022

(30) Foreign Application Priority Data
May 21, 2021 (JP) 2021-086069

(51) Int. Cl. H04W 12/06; H04W 4/029; H04W 4/80; H04W 4/48

(52) U.S. Cl. CPC H04W 12/06; H04W 4/029; H04W 4/80; H04W 4/48

(57) ABSTRACT

There is provided a control device that is configured to be installed in a casing, the control device comprising a control section configured to control operation of a control target device on a basis of a wireless signal that is compliant with a designated standard and is transmitted/received between a portable device and at least one communication device installed in the same casing, wherein the control section causes the control target device to perform a designated operation in a case where authenticity of the portable device is confirmed through authentication based on the wireless signal compliant with the designated communication standard and a designated range covers a position of the portable device estimated through position estimation of the portable device based on the wireless signal compliant with the designated communication standard.

### CROSS REFERENCE TO RELATED APPLICATION(S)

This application is based upon and claims benefit of priority from Japanese Patent Application No. 2021-086069, filed on May 21, 2021, the entire contents of which are incorporated herein by reference.

### BACKGROUND

The present invention relates to a control device, a non-transitory computer readable storage medium, and a system.

In recent years, technologies of authenticating a device on the basis of signals transmitted/received between devices have been developed. For example, JP H11-208419A discloses a system of authenticating a portable device on the basis of wireless signals transmitted/received between the portable device and an in-vehicle device.

### SUMMARY

The system disclosed in P H11-208419A uses low frequency (LF) band wireless signals and ultra high frequency (UHF) band wireless signals for the authentication. However, for example, the LF band wireless signals have very long wavelengths. Therefore, sometimes it is difficult to certainly establish wireless communication between devices at a distance more than several meters in a case where the LF band wireless signals are used within a reasonable power consumption and transmission power range.

Accordingly, the present invention is made in view of the aforementioned issue, and an object of the present invention is to improve certainty of authentication based on wireless communication between devices at a longer distance.

To solve the above-described problems, according to an aspect of the present invention, there is provided a control device that is configured to be installed in a casing, the control device comprising a control section configured to control operation of a control target device on a basis of a wireless signal that is compliant with a designated standard and is transmitted/received between a portable device and at least one communication device installed in the same casing, wherein the control section causes the control target device to perform a designated operation in a case where authenticity of the portable device is confirmed through authentication based on the wireless signal compliant with the designated communication standard and a designated range covers a position of the portable device estimated through position estimation of the portable device based on the wireless signal compliant with the designated communication standard.

In addition, to solve the above-described problems, according to another aspect of the present invention, there is provided a non-transitory computer readable storage medium having a program stored therein, the program causing a computer to function as a control device that is configured to be installed in a casing and causing the control device to achieve a control function of controlling operation of a control target device on a basis of a wireless signal that is compliant with a designated standard and is transmitted/received between a portable device and at least one communication device installed in the same casing, wherein the control function causes the control target device to perform a designated operation in a case where authenticity of the portable device is confirmed through authentication based on the wireless signal compliant with the designated communication standard and a designated range covers a position of the portable device estimated through position estimation of the portable device based on the wireless signal compliant with the designated communication standard.

In addition, to solve the above-described problems, according to another aspect of the present invention, there is provided a system comprising: a control device configured to be installed in a casing; and at least one communication device configured to be installed in the same casing, wherein the control device includes a control section configured to control operation of a control target device on a basis of a wireless signal that is compliant with a designated standard and is transmitted/received between a portable device and the at least one communication device installed in the same casing, and the control section causes the control target device to perform a designated operation in a case where authenticity of the portable device is confirmed through authentication based on the wireless signal compliant with the designated communication standard and a designated range covers a position of the portable device estimated through position estimation of the portable device based on the wireless signal compliant with the designated communication standard.

As described above, according to the present invention, it is possible to improve certainty of authentication based on wireless communication between devices at a longer distance.

### BRIEF DESCRIPTION OF THE DRAWINGS

FIG. 1 is a block diagram illustrating a configuration example of a system 1 according to a first embodiment of the present invention.

FIG. 2 is a sequence diagram for describing an example of a flow of a process performed in the system 1 according to the embodiment.

FIG. 3 is a sequence diagram for describing an example of a flow of a process performed in the system 1 according to the embodiment.

FIG. 4 is a block diagram illustrating a configuration example of a system 1 according to a second embodiment of the present invention.

FIG. 5 is a sequence diagram illustrating an example of a flow of a process performed in the system 1 according to the embodiment.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. First Embodiment

### 1.1. System Configuration Example

First, a configuration example of a system 1 according to a first embodiment of the present invention will be described.

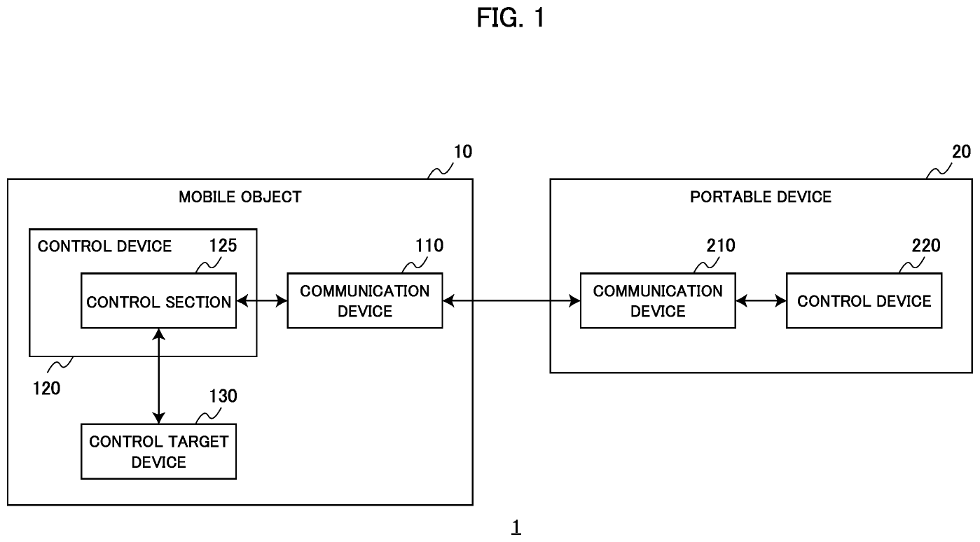

FIG. 1 is a block diagram illustrating a configuration example of the system 1 according to the first embodiment of the present invention.

As illustrated in FIG. 1, the system 1 according to the present embodiment may include a plurality of devices installed in a portable device and a mobile object 10.

### Mobile Object 10

The mobile object 10 according to the present embodiment is an example of a casing.

For example, the mobile object 10 may a vehicle, a ship, an airplane, or the like.

As illustrated in FIG. 1, the mobile object 10 according to the present embodiment may include a communication device 110, a control device 120, a control target device 130, and the like.

### Communication Device 110

The communication device 110 according to the present embodiment transmits/receives wireless signals to/from a communication device 210 of a portable device 20 in conformity with a designated communication standard (sometimes referred to as a first communication standard in the present disclosure).

Therefore, the communication device 110 according to the present embodiment is provided with an antenna for transmitting/receiving wireless signals compliant with the designated communication standard.

Examples of the designated communication standard according to the present embodiment include ultra-wideband (UWB) wireless communication.

On the other hand, the designated communication standard according to the present embodiment is not limited to the ultra-wideband wireless communication. Various kinds of communication standards for transmitting/receiving wireless signals that are useful for estimating a positional relation between the communication devices may be adopted as the designated communication standard according to the present embodiment.

In addition, for example, the estimation of the positional relation between the communication devices (position estimation) according to the present embodiment includes ranging for estimating a distance between the communication device 100 and the communication device 210.

The communication device 110 according to the present embodiment cooperates with the communication device 210 installed in the portable device 20 and performs the ranging for estimating a distance to the communication device 210 on the basis of the wireless signals that are compliant with the designated communication standard and is transmitted/received to/from the communication device 210.

Note that, the single mobile object 10 may include a plurality of the communication devices 110 according to the present embodiment.

In this case, each of the communication devices 110 installed in the mobile object 10 may perform ranging with regard to the communication device 210 installed in the portable device 20.

In addition, the position estimation according to the present embodiment is not limited to the ranging. For example, the position estimation according to the present embodiment may include angle estimation, coordinate estimation, and the like. In the angle estimation, an angle of the communication device 210 is estimated with respect to the communication device 110. IN the coordinate estimation, coordinates of the communication device with respect to the communication device 210 is estimated from results of the ranging and the angle estimation.

In addition to the wireless signals to be used for the positional relation, the communication device 110 according to the present embodiment may also transmit/receive wireless signals to be used by the control device 120 for authentication of the portable device 20.

At this time, the mobile object 10 may include a communication device 110 capable of transmitting/receiving both the wireless signals to be used for the positional relation and wireless signals to be used for the authentication.

Alternatively, the mobile object 10 may include a communication device 110 capable of transmitting/receiving the wireless signals to be used for the positional relation and a communication device 110 capable of transmitting/receiving the wireless signals to be used for the authentication.

### Control Device 120

The control device 120 according to the present embodiment includes a control section 125 configured to control operation of the control target device 130 on the basis of wireless signals that are compliant with the designated standard and are transmitted/received between the portable device 20 (more specifically, the communication device 210) and the at least one communication device 110 installed in the same portable device 10.

In addition, one of features of the control section 125 according to the present embodiment is to cause the control target device 130 to perform a designated operation in the case where authenticity of the portable device 20 is confirmed through the authentication based on the wireless signals compliant with the designated communication standard and a designated range covers the position of the portable device 20 estimated through position estimation of the portable device 20 (more specifically, the communication device 210) based on the wireless signals compliant with the designated communication standard.

In other words, in the system 1 according to the present embodiment, the authentication and the position estimation are performed on the basis of the wireless signals compliant with the same standard, and the control section 125 controls operation of the control target device 130 on the basis of results of the authentication and the position estimation.

The wireless signals useful for the position estimation such as ranging have features of short wavelengths and relatively longer reaching distances.

For example, in the case of UWB, the reaching distance exceeds 100 m while low power consumption is achieved.

Therefore, even in the case where the mobile object 10 is relatively apart from the portable device 20, the system 1 according to the present embodiment makes it possible to establish stable wireless communication between the mobile object 10 and the portable device 20 and control operation of the control target device of the mobile object 10 on the basis of a result of the wireless communication.

The functions of the control section 125 according to the present embodiment are implemented by various kinds of processors.

### Control Target Device 130

The control target device 130 according to the present embodiment may be various kinds of devices installed in the mobile object 10.

Examples of the control target device 130 according to the present embodiment include an engine, a lock device, and the like. The lock device is configured to perform control over unlocking/locking of a door of the mobile object 10.

For example, the control device 125 may instruct the lock device to unlock the door in the case where the authenticity of the portable device 20 is confirmed through the authentication and the designated range covers the estimated position of the portable device 20.

In addition, for example, the control device 125 may permit the engine to start in the case where the authenticity of the portable device 20 is confirmed through the authentication and the designated range covers the estimated position of the portable device 20.

### Portable Device 20

The portable device 20 according to the present embodiment is configured to be carried by a user who uses the mobile object 10 (such as an owner of the mobile object 10 or a person who has permission from the owner to use the mobile object 10).

As illustrated in FIG. 1, the portable device 20 according to the present embodiment may include the communication device 210 and a control device 220.

### Communication Device 210

The communication device 210 according to the present embodiment transmits/receives wireless signals to/from the communication device 110 of the mobile object 10 in conformity with the designated communication standard.

Therefore, the communication device 210 according to the present embodiment is provided with an antenna for transmitting/receiving wireless signals compliant with the designated communication standard.

### Control Device 220

The control device 220 according to the present embodiment controls wireless communication by the communication device 210 of the portable device 20.

The functions of the control device 220 according to the present embodiment are implemented by various kinds of processors.

The configuration example of the system 1 according to the present embodiment has been described above. Note that, the configuration described above with reference to FIG. 1 is a mere example. The configuration of the system 1 according to the present embodiment is not limited thereto.

The configuration of the system 1 according to the present embodiment may be flexibly modified in accordance with specifications and operations.

### 1.2. Details of Control

Next, details of the control by the control device 130 installed in the mobile object 10 according to the present embodiment will be described.

In the case of achieving the authentication and the position estimation of the portable device 20 on the basis of wireless signals compliant with a same standard, it is important to synchronize timings of transmission/reception of the wireless signals to be used for the authentication and the position estimation, between the communication device 110 and the communication device 210.

For example, the above-described synchronization of the timings may be triggered by a trigger signal transmitted by the communication device 210 of the portable device 20.

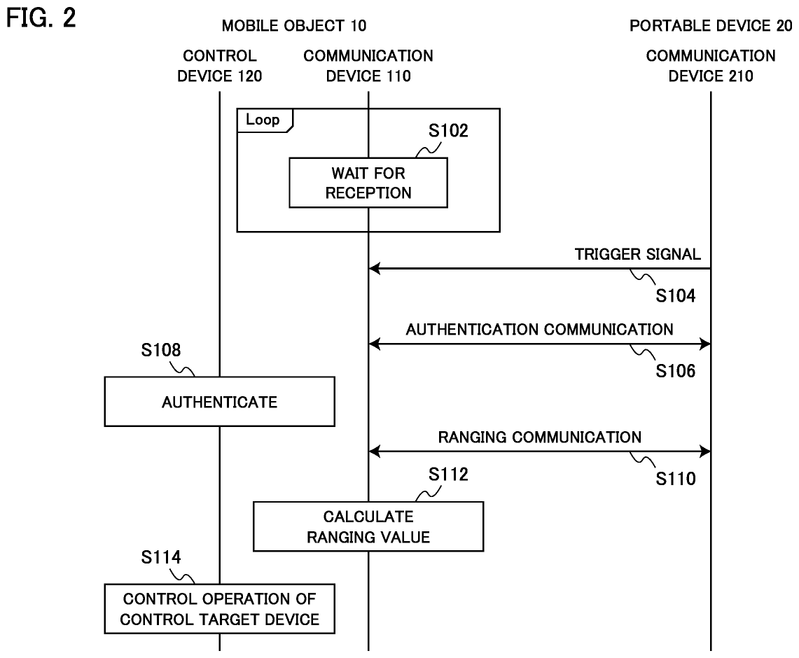

FIG. 2 is a sequence diagram for describing an example of a flow of a process performed in the system 1 according to the present embodiment.

Note that, hereinafter, a case where the ranging is performed as the position estimation will be described as an example.

In the case of the example illustrated in FIG. 2, the control device 120 first causes the communication device 110 to repeatedly wait for receiving a wireless signal compliant with a designated communication standard (Step S102).

The reception waiting step in Step S102 may be repeated periodically, for example, at a certain interval.

On the other hand, for example, in the case where the user has operated an application on the portable device 20, the communication device 210 transmits a trigger signal compliant with the designated communication standard under the control of the control device 220 (Step S104).

In the case where the trigger signal is transmitted in Step S104 while the communication device 110 is in the reception waiting state in Step S102, the communication device 110 is capable of receiving the trigger signal.

By causing the communication device 110 to enter the reception waiting state and a non reception waiting state alternatively and repeatedly, it is possible to effectively reduce electric power consumption associated with the reception waiting state.

In the case where the communication device 110 has received the trigger signal compliant with the designated communication standard, the control section 125 of the control device 120 installed in the mobile object 10 may cause the communication device 110 to start transmitting/receiving a wireless signal compliant with the designated communication standard, the wireless signal being to be used for the authentication or the position estimation.

Note that, FIG. 2 exemplifies a case where wireless signals to be used for the authentication are transmitted/received (authentication communication: Step S106), and then wireless signals to be used for the ranging are transmitted/received (ranging communication: Step S110).

In the example illustrated in FIG. 1, the control section 125 first causes the communication device 110 to perform operation corresponding to a predecided authentication communication sequence in the case where the communication device 110 has received the trigger signal.

In a similar way, the control device 220 of the portable device 20 may cause the communication device 210 to perform operation corresponding to the authentication communication sequence.

For example, in the authentication communication step, the control section 125 may cause the communication device 110 to wait for reception in the case of a sequence in which the communication device 210 transmits a first signal.

Alternatively, in the case of a sequence in which the communication device 110 transmits the first signal, the control section 125 may cause the communication device 110 to transmit the first signal.

Note that, it is sufficient to appropriately design the authentication communication sequences according to the present embodiment, depending on authentication technologies to be adopted.

For example the authentication sequences according to the present embodiment may include transmission/reception of a request signal for requesting information for conforming the authenticity of the portable device 20, a response signal including various kinds of information in response to the request signal, and the like.

The control section 125 according to the present embodiment authenticates the portable device 20 (Step S108) on the basis of information included in the wireless signal received by the communication device 110 through the authentication communication in Step S106.

Next, the control section 125 causes the communication device 110 to perform operation corresponding to a predecided ranging communication sequence.

In a similar way, the control device 220 of the portable device 20 may cause the communication device 210 to perform operation corresponding to the ranging communication sequence.

For example, in the ranging communication step, the control section 125 may cause the communication device 110 to wait for reception in the case of a sequence in which the communication device 210 transmits a first signal.

Alternatively, in the case of a sequence in which the communication device 110 transmits the first signal, the control section 125 may cause the communication device 110 to transmit the first signal.

It is sufficient to appropriately design the ranging communication sequences according to the present embodiment, depending on methods to be adopted.

The communication device 110 calculates a ranging value (Step S112) also on the basis of the wireless signals transmitted/received through the ranging communication in Step S110.

For example, a method of calculating the ranging value in the case where the ranging communication includes a ranging request and a ranging response will be described. The ranging request is transmitted from one of the communication devices 110 and 210, and the ranging response is transmitted from the other of the communication devices 110 and 120 in response to the ranging request.

In this case, the communication device 110 is capable of calculating the ranging value on the basis of a time period ΔT1 and a time period ΔT2. The time period ΔT1 is time from transmission of the ranging request to reception of the ranging response, and the time period ΔT2 is time from reception of the ranging request to transmission of the ranging response.

More specifically, the communication device 110 subtracts the time period ΔT2 from the time period ΔT1 to calculate time taken to perform two-way communication of the ranging request and the ranging response. Subsequently, the communication device 110 divides the calculated time by 2 to calculate time taken to perform one-way communication of the ranging request or the ranging response.

In addition, the communication device 110 to calculate the ranging value by multiplying the value obtained through (time period ΔT1−time period ΔT2)/2 by speed of the signals.

Note that, it is also possible for the communication device 210 of the portable device 20 to calculate the ranging value. In this case, it is sufficient for the communication device 210 to transmit the calculated ranging value to the communication device 110.

The communication device 110 and the communication device 210 are capable of calculating the ranging value by receiving the value of the time period ΔT1 or the time period ΔT2 from a communication partner.

Next, the control section 125 of the control device 120 installed in the mobile object 10 controls operation of the control target device 130 (Step S114) on the basis of a result of the authentication obtained in Step S108 and the ranging value calculated in Step S112.

For example, the control device 125 according to the present embodiment may cause the control target device to perform a designated operation in the case where the authenticity of the portable device 20 is confirmed through the authentication and the designated range covers the ranging value.

The example of the flow of the process performed in the system 1 has been described above with reference to FIG. 2.

Note that, in the above description, the communication device 210 transmits the trigger signal when the user has operated the application on the portable device 20. However, the flow of the process in the system 1 according to the present embodiment is not limited thereto.

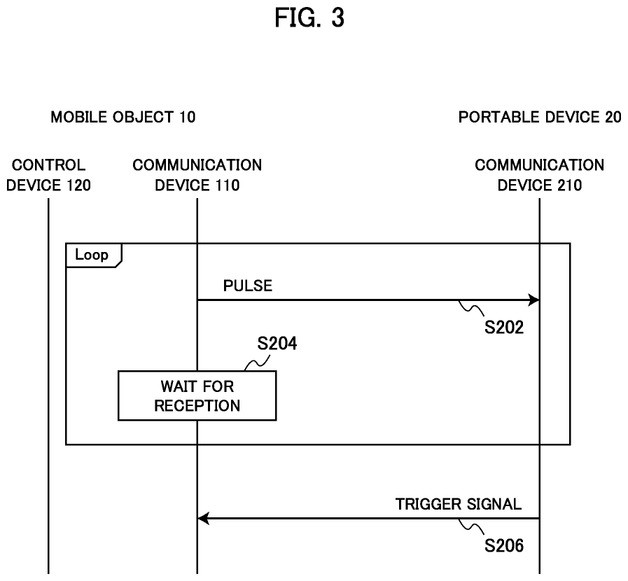

For example, in the case of an example illustrated in FIG. 3, the control section 135 causes a communication device to repeatedly transmit a pulse compliant with a designated communication standard (Step S202) and wait for receiving a wireless signal compliant with the designated communication standard (Step S204).

In this case, the control device 220 of the portable device 20 may cause the communication device 210 to transmit a trigger signal (Step S206) on the basis of the pulse received by the communication device 210 in Step S202.

According to the above-described flow, it is possible to transmit/receive the trigger signal and subsequently perform the authentication and the ranging without requiring the user to operate the application or to perform any other operation.

Note that, a flow of processes performed in the system 1 after transmission/reception of the trigger signal in Step S206 in FIG. 3 is substantially the same as Steps S106 to S114 in FIG. 2. Therefore, the description of the flow of the processes is omitted.

### 2. Second Embodiment

### 2.1. System Configuration Example

Next, a second embodiment of the present invention will be described.

According to the first embodiment, the authentication communication and the ranging communication is triggered by transmission/reception of the trigger signal compliant with the designated communication standard.

However, the authentication communication and the ranging communication may be triggered by wireless communication compliant with another communication standard that is different from the designated communication standard.

First, a configuration example of a system 1 according to the second embodiment of the present invention will be described.

Note that, hereinafter, a description will be given while focusing on a difference from the first embodiment, and repeated explanation will be omitted with regard to functions and the like that overlaps the first embodiment.

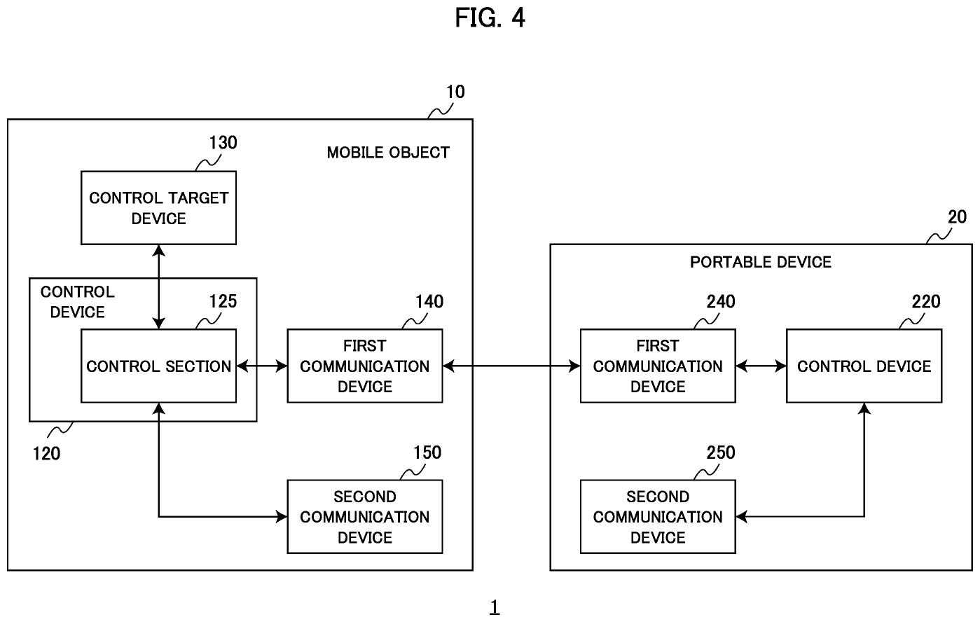

FIG. 4 is a block diagram illustrating the configuration example of the system 1 according to the second embodiment of the present invention.

In the case of the example illustrated in FIG. 4, a mobile object 10 includes a first communication device 140 and a second communication device 150 instead of the communication device 110.

### First Communication Device 140

The first communication device 140 according to the present embodiment transmits/receives wireless signals to/from a first communication device 240 of a portable device 20 in conformity with a designated communication standard (hereinafter, referred to as a first communication standard for explanatory convenience).

Therefore, the first wireless communication device 140 according to the present embodiment is provided with an antenna for transmitting/receiving the wireless signals compliant with the first communication standard.

Note that, the first communication device 140 according to the present embodiment may have a configuration basically similar to that of the communication device 110 according to the first embodiment, but the first communication device 140 is different from the communication device 110 in that the first communication device 140 receives no trigger signal.

### Second Communication Device 150

The second communication device 150 according to the present embodiment transmits/receives wireless signals to/from a second communication device 250 of the portable device 20 in conformity with a communication standard (referred to as a second communication standard for explanatory convenience) that is different from the designated communication standard.

Therefore, the second wireless communication device 150 according to the present embodiment is provided with an antenna for transmitting/receiving wireless signals compliant with the second communication standard.

Standards capable of transmitting/receiving wireless signals having relatively long reaching distances may be adopted as the second communication standard according to the present embodiment.

For example, the second communication standard according to the present embodiment may be Bluetooth Low Energy (BLE) (registered trademark).

Next, a functional configuration example of the portable device 20 according to the present embodiment will be described.

As illustrated in FIG. 4, the portable device 20 according to the present embodiment may include the first communication device 110 and the second communication device 250 instead of the communication device 210.

### First Communication Device 240

The first communication device 240 according to the present embodiment transmits/receives wireless signals to/from the first communication device 140 of the mobile object 10 in conformity with the first communication standard.

Therefore, the first wireless communication device 240 according to the present embodiment is provided with an antenna for transmitting/receiving the wireless signals compliant with the first communication standard.

### Second Communication Device 250

The second communication device 250 according to the present embodiment transmits/receives wireless signals to/from the second communication device 150 of the mobile object 10 in conformity with the second communication standard.

Therefore, the second wireless communication device 150 according to the present embodiment is provided with an antenna for transmitting/receiving wireless signals compliant with the second communication standard.

The configuration example of the system 1 according to the present embodiment has been described above. Note that, the configuration described above with reference to FIG. 4 is a mere example. The configuration of the system 1 according to the present embodiment is not limited thereto.

The configuration of the system 1 according to the present embodiment may be flexibly modified in accordance with specifications and operations.

### 2.2. Details of Control

Next, details of the control by a control section 125 according to the present embodiment will be described.

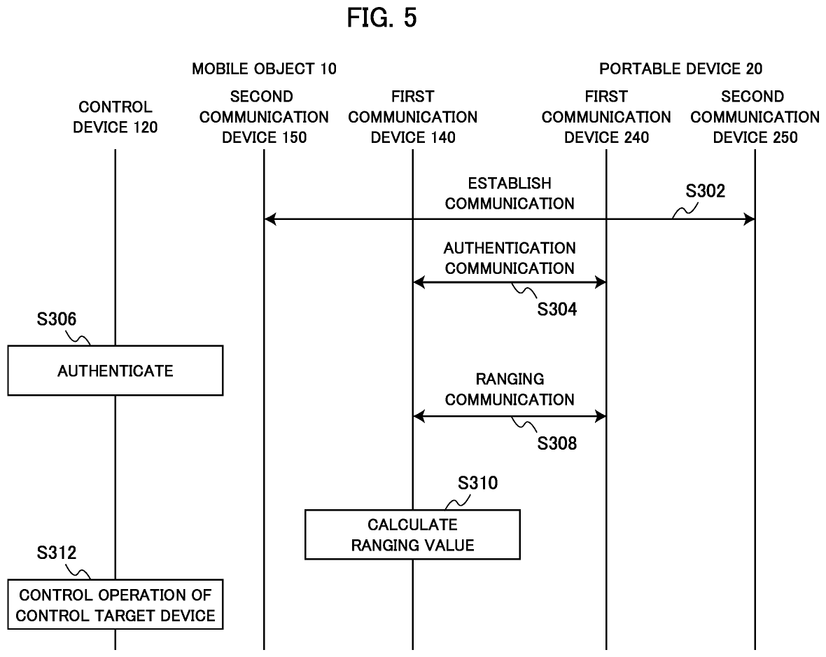

FIG. 5 is a sequence diagram illustrating an example of a flow of a process performed in the system 1 according to the present embodiment.

In the case of the example illustrated in FIG. 5, wireless communication compliant with the second communication standard is first established between the second communication device 150 of the mobile object 10 and the second communication device 250 of the portable device 20 (Step S302).

For example, the control section 125 may determine that the wireless communication compliant with the second communication standard is established between the second communication device 150 and the second communication device 250 in the case where the BLE is adopted as the second communication standard and connection is established between the second communication device 150 and the second communication device 250.

Alternatively, for example, the control section 125 may determine that the wireless communication compliant with the second communication standard is established between the second communication device 150 and the second communication device 250 when the second communication device 150 has received an advertisement transmitted from the second communication device 250 of the portable device 20.

The control section 125 according to the present embodiment causes the first communication device 140 to start the authentication communication (Step S304) in the case where the wireless communication compliant with the second communication standard is established between the second communication device 150 and the second communication device 250.

In a similar way, the control device 220 of the portable device 20 causes the first communication device 240 to start the authentication communication in the case where the wireless communication compliant with the second communication standard is established between the second communication device 150 and the second communication device 250.

In other words, the system 1 according to the present embodiment starts the authentication communication between the first communication device 140 and the first communication device 240 in the case where it is determined that the position of the portable device 20 is within a range capable of providing the wireless communication compliant with the second communication standard.

The above-described process makes it possible to start the authentication communication only in the case where the position of the portable device 20 is within the range capable of providing the wireless communication compliant with the second communication standard. Therefore, it is possible to significantly reduce electric power necessary to wait for reception.

Note that, processes performed in Steps S306 to S312 in FIG. 5 are substantially the same as Steps S108 to S114 in FIG. 2. Therefore, the description of the processes is omitted.

### 2. Supplement

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

For example, the above embodiment has exemplified the case where the authentication communication and the authentication are first performed, then the ranging communication is performed, and the ranging value is calculated. However, the order of the above-described processes may be reversed.

In addition, in the case where the authentication is performed first but the authenticity of the portable device 20 is not confirmed, the control section 125 may perform control in such a manner that the ranging communication is not started.

On the other hand, in the case where the authentication is performed first but the calculated ranging value is not within the designated range, the control section 125 may perform control in such a manner that the authentication communication is not started.

In addition, the series of processes performed by each of the devices described herein may be achieved by a program stored in a non-transitory computer readable storage medium. For example, each program is loaded into RAM, and executed by a processor such as a CPU when a computer executes each of the program. The storage medium may be a magnetic disk, an optical disc, a magneto-optical disc, flash memory, or the like, for example. Alternatively, the above-described programs may be distributed via a network without using the storage medium, for example.

What is claimed is:

1. A control device that is configured to be installed in a casing, the control device comprising
a control section configured to control operation of a control target device on a basis of a wireless signal that is compliant with a designated standard and is transmitted/received between a portable device and at least one communication device installed in the same casing,
wherein the control section causes the control target device to perform a designated operation in a case where authenticity of the portable device is confirmed through authentication based on the wireless signal compliant with the designated communication standard and a designated range covers a position of the portable device estimated through position estimation of the portable device based on the wireless signal compliant with the designated communication standard.

2. The control device according to claim 1,
wherein the control section causes the communication device to repeatedly wait for receiving the wireless signal compliant with the designated communication standard, and in a case where the communication device has received a trigger signal compliant with the designated communication standard, the control section causes the communication device to start transmitting/receiving the wireless signal that is compliant with the designated communication standard and is to be used for the authentication or the position estimation.

3. The control device according to claim 1,
wherein the control section causes the communication device to repeatedly transmit a pulse compliant with the designated communication standard and wait for receiving the wireless signal compliant with the designated communication standard, and in a case where the communication device has received a trigger signal compliant with the designated communication standard and transmitted from the portable device that has received the pulse, the control section causes the communication device to start transmitting/receiving the wireless signal that is compliant with the designated communication standard and is to be used for the authentication or the position estimation.

4. The control device according to claim 1,
wherein the control section causes the communication device to start transmitting/receiving the wireless signal that is compliant with the designated communication standard and is to be used for the authentication or the position estimation in a case where wireless communication compliant with another communication standard that is different from the designated communication standard is established between the portable device and another communication device that is different from the communication device installed in the same casing.

5. The control device according to claim 1,
wherein the control section causes the communication device to transmit/receive a wireless signal that is compliant with the designated communication standard and is to be used for the authentication, and then causes the communication device to transmit/receive a wireless signal that is compliant with the designated communication standard and is to be used for the position estimation.

6. The control device according to claim 1,
wherein the position estimation including ranging for estimating a distance between the communication device and the portable device.

7. The control device according to claim 1,
wherein the designated communication standard includes ultra-wideband wireless communication.

8. The control device according to claim 4,
wherein the other communication standard includes Bluetooth Low Energy (BLE).

9. The control device according to claim 1,
wherein the casing includes a mobile object.

10. A non-transitory computer readable storage medium having a program stored therein, the program
causing a computer to function as a control device that is configured to be installed in a casing and
causing the control device to achieve a control function of controlling operation of a control target device on a basis of a wireless signal that is compliant with a designated standard and is transmitted/received between a portable device and at least one communication device installed in the same casing,
wherein the control function causes the control target device to perform a designated operation in a case where authenticity of the portable device is confirmed through authentication based on the wireless signal compliant with the designated communication standard and a designated range covers a position of the portable device estimated through position estimation of the portable device based on the wireless signal compliant with the designated communication standard.

11. A system comprising:
a control device configured to be installed in a casing; and
at least one communication device configured to be installed in the same casing,
wherein the control device includes a control section configured to control operation of a control target device on a basis of a wireless signal that is compliant with a designated standard and is transmitted/received between a portable device and the at least one communication device installed in the same casing, and
the control section causes the control target device to perform a designated operation in a case where authenticity of the portable device is confirmed through authentication based on the wireless signal compliant with the designated communication standard and a designated range covers a position of the portable device estimated through position estimation of the portable device based on the wireless signal compliant with the designated communication standard.
